(19) United States
(12) Patent Application Publication
(10) Pub. No.: US 2022/0114178 A1
(43) Pub. Date: Apr. 14, 2022

(54) EFFICIENT GRAPH QUERY PROJECTIONS ON TOP OF PROPERTY VALUE STORAGE SYSTEMS

(71) Applicant: Oracle International Corporation, Redwood Shores, CA (US)

(72) Inventors: Vlad Ioan Haprian, Zurich (CH); Mikael Gonzalez Morales, Zurich (CH); Laurent Daynes, Saint-Ismier (FR); Zhen Hua Liu, San Mateo, CA (US); Danica Porobic, Zurich (CH); Marco Arnaboldi, Zurich (CH); Jean-Pierre Lozi, Zurich (CH); Hugo Kapp, Zurich (CH); Sungpack Hong, Palo Alto, CA (US); Shasank Kisan Chavan, Menlo Park, CA (US); Hassan Chafi, San Mateo, CA (US)

(21) Appl. No.: 17/162,564

(22) Filed: Jan. 29, 2021

Related U.S. Application Data
(60) Provisional application No. 63/090,955, filed on Oct. 13, 2020.

(51) Int. Cl. G06F 16/2455; G06F 16/26; G06F 16/2453; G06F 16/248; G06F 16/22

(52) U.S. Cl. CPC G06F 16/24552; G06F 16/26; G06F 16/2237; G06F 16/248; G06F 16/24539

(57) ABSTRACT

Techniques are provided for processing a graph query by exploiting an in-memory graph index and minimizing the number of storage accesses needed to project properties of generated paths. A predefined number of paths from a graph query runtime is accumulated, using different data structures, before executing storage accesses necessary to retrieve all properties needed. A first data structure stores all paths from the graph query runtime that hit cache(s) entirely. A second data structure stores paths that do not hit caches at any level or only a subset of the levels does. Once any of these data structures are full, result rows are produced based on the two data structures prior to extracting more paths from the graph query runtime.

### BENEFIT CLAIM

This application claims the benefit under 35 U.S.C. § 119(e) of provisional application 63/090,955, filed Oct. 13, 2020, and titled “Efficient Graph Query Projections on top of Relational Database Systems,” the entire contents of which is hereby incorporated by reference for all purposes as if fully set forth herein.

### FIELD OF THE INVENTION

The present disclosure relates to techniques for processing graph queries. More specifically, the disclosure relates to efficient graph query projections on top of property value storage systems, such as relational database systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Graph analytics is an important kind of data analytics. Relational databases increasingly allow their users to define property graphs from relational tables and to query them using graph pattern matching queries. Most products, such as Microsoft SQL Server and SAP HANA, limit users to define a graph out of a single vertex table and edge table. These graphs are called homogeneous graphs. More advanced systems, such as IBM DB2, may define graph out of multiple vertex and edge tables. For example, one can create a heterogeneous graph out of the existing tables in a database by mapping every dimension table to a vertex table and every fact table to an edge table. The only constraint is that vertex tables should have a primary key column and the edge tables should associate foreign keys corresponding to the primary keys into two different/same vertex tables.

Graph querying and pattern matching enables interactive exploration of graphs, similar to how SQL enables interactive exploration of relational data. Pattern matching refers to finding patterns in the graph that are homomorphic to a target pattern, such as a triangle. In addition to the structural pattern, users can add projections, filters, etc., similar to SQL. For simplicity, the term “graph queries” used herein refers to “graph querying and pattern matching.”

Graph queries are very challenging workloads as they put the focus on edges, which are the connections in the data. Therefore, executing graph queries might explore immense amounts of intermediate results, and queries can quickly explode in terms of memory usage. Additionally, graph queries exhibit very irregular access patterns with limited memory locality, as the query patterns and the connections in the data dictate the accesses.

Graph queries are efficiently processed by using specialized graph indexes that allows fast edge traversal. Once a path is matched, properties of vertices/edges along the path need to be retrieved (e.g., property projections). For example, the query shown in Table 1 matches a, b, and c and projects some of their properties.

TABLE 1

SELECT * FROM GRAPH TABLE(MY GRAPH, MATCH (a) −> (b) −> (c)
COLUMNS (a.age, b.name, c.sal));

Property projections on top of graph queries can be very challenging. Graph indexes, such as CSR (Compressed Sparse Row), support efficient edge navigation but only store content references, such as row ids or row ordinal numbers, to the actual rows that contain the projection property information. Projecting a property still requires the content reference to obtain the column value. Unfortunately, this process implies a random data access on the underlying table rows. This is different from native graph storage where graph components (e.g., vertices, edges) and its content are physically clustered together.

One industry solution is for systems to process graph queries using a traditional relational JOIN oriented approach. A RDBMS translates a graph query into a join query, which is processed using its existing SQL engine. Table 2 shows an example graph query and its corresponding rewritten query.

TABLE 2

# Graph query written in SQL/PGQ:
SELECT * FROM GRAPH_TABLE(MY_GRAPH, MATCH (a) −> (b) COLUMNS
(a.age, b.age));
# Assuming a graph with one vertex table (VT1) and one
edge table (ET11 between VT1 and VT1).
# The SQL/PGQ query translated to a SQL query
SELECT a.age, b.age FROM VT1 a, ET11 e, VT1 b where e.src = a.id
AND e.dst = b.id;

In such systems, the cost of the graph query is dominated by the SQL query.

Another industry solution is for systems to use an in-memory graph index to process graph queries. However, random accesses to retrieve values for vertices/edges involved in projections offset the benefit of using a graph index. To mitigate the problem of slow random accesses, these systems usually materialize all potentially projected column values in memory and enable constant-time fast access to individual row's columns. This, however, may require memory resources beyond what is available for executing a query.

Discussed herein are approaches for processing a graph query by exploiting an in-memory graph index, while minimizing a number of storage accesses, to project properties of generated paths.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 illustrates an example graph and a corresponding CSR representation thereof.

FIG. 2 illustrates an example control flow of an implementation of projecting properties.

FIG. 3 illustrates an example graph schema.

FIG. 4 illustrates an example instantiation tree.

FIG. 5 illustrates an example materialized paths data structure.

FIG. 6 illustrates an example lazy materialization buffer.

FIG. 7 illustrates a visual representation of vertices being prefetched on a graph.

FIGS. 8A-8B illustrate an example control flow of an implementation of projecting properties.

FIGS. 9A, 9B illustrate example diagrams of memory allocation.

FIG. 10 illustrates an example flow diagram that depicts a process for projecting properties of generated paths.

FIG. 11 illustrates a block diagram of a computing device in which the example embodiment(s) of the present invention may be embodiment.

FIG. 12 illustrates a block diagram of a basic software system for controlling the operation of a computing device.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques described herein cache properties of already visited graph components (e.g., vertices, edges) in a generated path and prefetch properties of graph components that have a high likelihood to appear in next generated paths by exploiting an in-memory graph index. A generated path is as an ordered list of graph component identifiers (e.g., vertex identifiers, edge identifiers) matching the input path pattern.

In an embodiment, given a path produced or generated by the graph query runtime, properties of the vertices in the path are checked to see if they are already cached. If they are cached, the properties of those vertices are fetched from the cache and the path is output. Otherwise, if they are not cached, the path is stored in a lazy-materialization buffer in order to delay its materialization. When the lazy-materialization buffer becomes full, the underlying storage, such as a table, is accessed to fetch properties of the vertices present in the buffer and properties of the vertices likely to appear in the next paths. The likelihood of a vertex to appear in a next path is determined by exploiting connectivity information available in graph indexes and the state of the path pattern query engine (e.g., what tables are being processed). The storage access result is saved in cache.

### Compressed Sparse Rows Overview

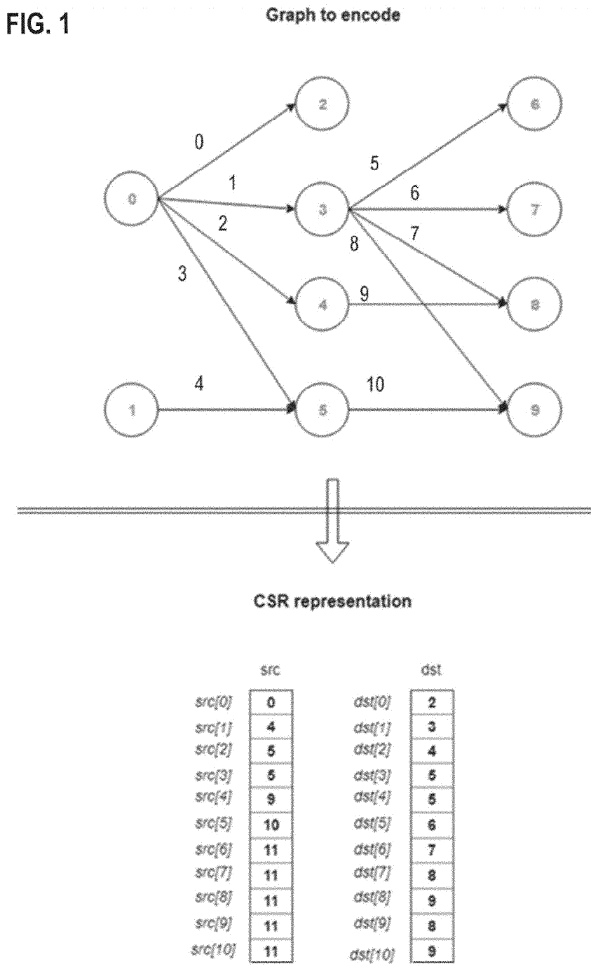

A graph may be represented by an in-memory graph index, such as compressed sparse rows (CSR). This representation is useful in graph processing engines because of its compact size and its neighbor caching behavior. The CSR representation for a graph G with n vertices labeled from 0 to n−1, and m edges, labeled from 0 to m−1, includes two arrays, src and dst. FIG. 1 illustrates an example graph and a corresponding CSR representation thereof.

Each vertex in the graph is associated with a unique identifier allocated from a set of numbers. The unique identifier behaves as the src array index. A vertex id is referred to herein as “vid.” The src array will have size n+1. For every i∈{0, 1, . . . , n−1}, the value stored in src[i] will be the position in the dst array for the first neighbor of vertex i. The last position of src array stores the value m, i.e., src[n]=m.

Similarly, each edge in the graph is associated with a unique identifier that behaves as the dst array index. The edge identifier is referred to herein as Ni (neighbor index). The dst array will have size m. For every i∈{0, 1, . . . , n−1}, the neighbors of vertex i are stored at the positions between src[i] and src[i+1], meaning that all the neighbors of a vertex are stored consecutively which helps while traversing all the neighbors of a specific vertex.

### In-Memory Graph Query Runtime Overview

In an embodiment, an in-memory graph query runtime may be integrated inside a RDBMS to improve efficiency of graph queries. The graph query runtime has access to a CSR that is in memory for optimizing a graph pattern matching operation. The graph query runtime may be represented in the RDBMS as a graph table operator. An example graph query runtime is discussed in co-pending U.S. application Ser. No. 16/710,740, titled “Hybrid In-Memory BFS-DFS Approach for Computing Graph Queries against Homogeneous Graphs inside Relational Database Systems,” filed Dec. 11, 2019,” wherein the entire contents of which are hereby incorporated by reference as if fully set forth herein.

In an embodiment, the graph table operator (also referred to as GRAPH_TABLE) computes all paths matching a given target pattern on a given graph and returns a table with number of rows equal to the number of paths matched. The GRAPH_TABLE includes a sequence of match operators for evaluating a path pattern expression. Each match operator in the sequence of match operators receives as input the result of a previous match operator. Each match operator processes a single hop in a path (e.g., edge to follow+destination). Each match operator is specialized to a specific task. Assembling match operators into a path pattern expression is performed by a path pattern match compiler during query compilation. The entire path pattern expression produces paths according to the target pattern.

In an embodiment, match operators perform their logic over multiple graph components in a pipelined manner and produce a number of matches that they store in a result set. The first match operator of a path pattern expression always feeds on the CSR and fills a result set that identifies a number of matching vertices. This result set serves as input to the next match operator in the path pattern expression which will produce a set of matching vertices corresponding to that stage (and edges that lead to these vertices). When the last match operator has filled its result set, the GRAPH_TABLE can then fill its output row-set with entire path match. Once the row-set is filled, control is returned to the parent of the graph table operator which then consumes the rows.

In an embodiment, there are three types of match operators. One type of match operator is a Root Node Match (RNM) operator. The RNM operator is responsible for computing the vertices which match the first or root node of the pattern. The RNM operator finds the first or root level vertices that match the pattern. Another type of match operator is an Intermediate Neighbor Match (NM) operator. The NM operator will start from a set of input vertices and produces a fixed number of neighbors for each of them. The NM operator is only used for intermediate nodes in the pattern and is not for the first or last node in the pattern. Yet another type of match operator is a Leaf Neighbor Match (LNM) operator. The LNM operator is similar to the NM operator, but it is only used for matching the last node in the pattern. The LNM operator finds the last or leaf level vertices that match the pattern.

Each match operator is associated with a data structure where it stores the current state, such as the matched vertices by the match operator, the number of valid rows, etc.

A root level data structure stores information about vertices matched by the RNM operator in a plurality of columns, which are treated and referred to as arrays. The root level data structure includes the following arrays: Ri (Root Index) array, Si (Start Index) array, Li (Last Index) array, and Next Valid array, each of them storing on row j.

The intermediate level data structure stores information about vertices matched by the NM operator in a plurality of columns, which are treated and referred to as arrays. The intermediate level data structure includes the following arrays: Ni (neighbor index) array, Si array, Li array, and Next Valid array. The last three arrays—Si, Li, and Next Valid—are similarly configured as the Si array, Li array, and Next Valid array the root level data structure. The Ri array is replaced by the Ni array.

The leaf level data structure stores information about vertices matched by the LNM operator in a plurality of columns, which are treated and referred to as arrays. In an embodiment, the leaf level data structure contains only the Ni and Next Valid arrays. Since the leaf match operator does not have a next operator, the Si and Li arrays are undefined. Similar to the intermediate level, the Ni array can be replaced with a Neighbor Id array if no information from the edge leading to the last vertex of the path pattern is needed (e.g., no edge predicate, or no projection of any properties of that edge).

### Top Level Design

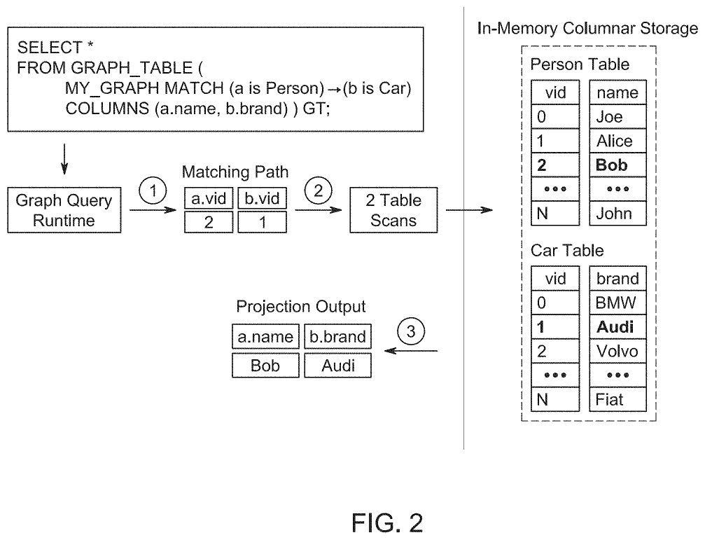

FIG. 2 illustrates a control flow of a straightforward implementation of projecting properties. The straightforward implementation works as follows:
1. One path is extracted from the runtime.
2. To recover the properties of this path, N storage accesses (e.g., table accesses) are executed, where N is the number of levels of the path pattern doing projections.
3. Results are copied into the properties into the GRAPH_TABLE output result.
4. Steps 1-3 are be repeated for the next path.

The straightforward implementation is executing (N*M) storage accesses in total, where N is the number of levels doing projections and M the number of paths matching the path pattern. The number of storage accesses executed makes this implementation extremely inefficient.

In contrast to the straightforward implementation, the current solution minimizes the number of storage accesses needed to project properties of generated paths. In an embodiment, the current solution includes the following components:
1. A caching mechanism efficiently reuses existing results and avoids the need to retrieve the same properties multiple times. The caching mechanism reduces the total number of storage accesses executed.
2. A path processing technique processes paths by batches instead of one path at a time. Processing the paths by batches significantly reduces the number of storage accesses done by the system to fetch the projected properties. The size of the batch can be configured, allowing for control of the memory footprint of current solution. Paths matched by the graph query runtime are materialized in two data structures:
   a. Materialized paths: The materialized paths data structure stores the paths fetched from the graph query runtime that hit the cache entirely (properties of all vertices are present in the cache). Paths stored in this data structure can be returned immediately without needing to perform any storage access. This data structure is only used if caching is enabled.
   b. Lazy materialization buffer: Paths stored in the lazy materialization buffer are either not hitting the caches at any level or only a subset of the levels does. A goal is to delay as much as possible a storage access operation, to make sure that the cost of initiating a storage access is amortized.
3. A data prefetching technique prefetches data by leveraging the information provided by the graph query runtime and an in-memory graph index (e.g., CSR). This prefetching technique ensures that the data being prefetched appears in the upcoming paths matched by the graph query runtime. Thus, a storage access operation is fully utilized to fetch as much meaningful data as possible.
4. Specialized control flows that, based on the query executed and the memory available, behave differently in order to provide the best performance.
5. Finally, a memory allocation algorithm determines how much memory each of the structures in the current invention should use for optimal performance.
   Each of these components are discussed in detail below.

When building the graph table operator to access the CSR-like graph index, storage access operators are built for all vertex tables so that during run time, only proper row accessing information need to be bound. When retrieving columns for a table with caching enabled, the rows whose columns are requested are identified using a bit vector that represent row ordinal position.

For the sake of simplicity, the current solution is described herein for projecting vertex properties. However, projecting edge properties can be implemented in the exact same way.

### Caching Mechanism

An intuition behind caching is that if a vertex i is connected to multiple vertices, then it is likely to appear in multiple paths returned by the graph query runtime. In other words, multiple paths returned by the graph query runtime will contain vertex i. Therefore, caching the properties of vertex i can help reduce the total number of storage accesses executed. Highly connected vertices are expected to be present in many graph topologies, for instance in social graphs.

When processing a graph query, such as (a)->(b)->(c), each level has an independent, in-memory, cache associated to it. This cache is row-oriented and has a fixed size, which may be statically assigned (e.g., computed once before execution time) or dynamically assigned, but can be different for every level.

The cache data structure contains a mapping from an integer identifier (e.g., graph component ID) to the properties projected at this level. The caches are filled after getting the results from storage accesses.

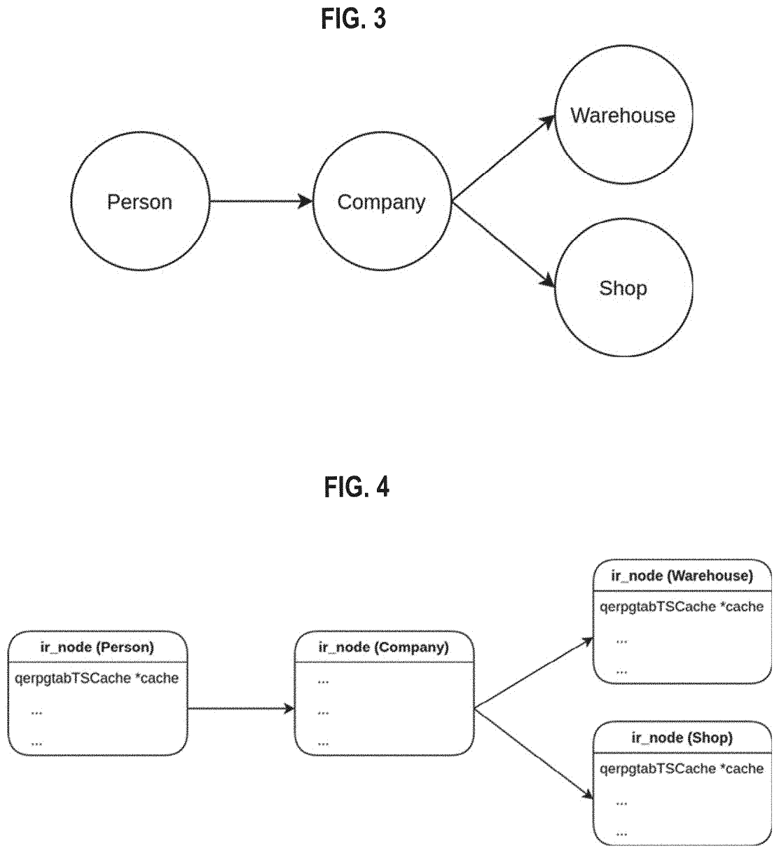

As an illustration of how caches are allocated, assume, without loss of generality, the graph query shown in Table 3 and the corresponding graph schema illustrated in FIG. 3.

TABLE 3
SELECT * FROM GRAPH TABLE(MY_GRAPH, MATCH (a) −> (b) −> (c) COLUMNS
(a.age, c.age, c.owner));

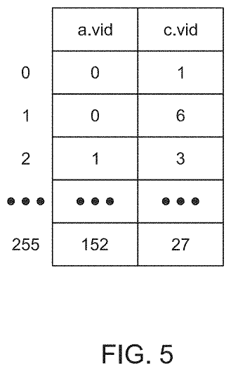

This graph query will generate an instantiation tree illustrated in FIG. 4. This instantiation tree is a tree of a data structure called it node, which is an intermediate representation for the in-memory GRAPH_TABLE execution plan. Each node carries the information if whether or not it is doing projection. If it does, it will have a pointer to a cache data structure.

In example shown in FIG. 4, three different caches are allocated with the following key-value pairs:
the Person cache with ID {age},
the Warehouse cache with ID {age, owner}, and
the Shop cache with ID {age, owner}.

Having cache per level also enables using different cache size per level or to enable/disable caching for a specific level. This versatility allows for caches to be configured differently based on the topology of the queried graph, resulting in a much more efficient usage of memory and finer control over performance.

### Path Processing

To prevent processing one path at a time and to fully utilize the caching system described above, the current solution, in an embodiment, uses two data structures: (1) materialized path and (2) lazy materialization buffer.

In an embodiment, a predefined number of paths is accumulated from the graph query runtime before executing storage accesses necessary to get all the properties needed. To do so, given that once a path is fetched from the runtime, all references to this path are lost, this path must materialize in order to be able to project its properties later. This is a goal of these two new data structures.

Materialized Paths. The materialized paths data structure stores the paths fetched from the graph query runtime that hit the cache entirely. If the properties of all the levels doing projection are already in the cache, it means that this path can be written out without needing to perform any storage access. This data structure is only used if caching is enabled.

To materialize a path, the information copied is the vertex identifier (vid) of each level. Thus, the paths are simply stored as a sequence of vertex identifiers. Given that the caches are indexed with respect to yids, they can later be used to access the properties that are going to be returned.

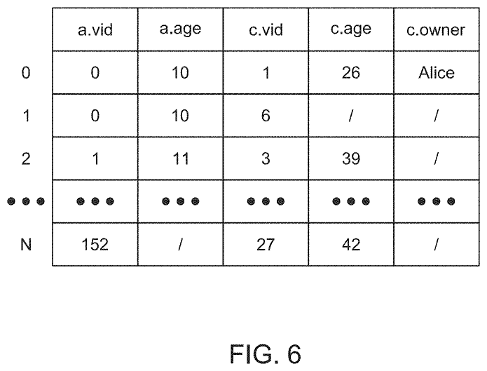

FIG. 5 illustrates a visual representation of the materialized paths data structure when executing a graph query with the path pattern (a)->(b)->(c) and projecting properties at level (a) and (c).

Lazy Materialization Buffer. Similarly, the lazy materialization buffer is also used to store paths fetched from the graph query runtime. However, the paths stored in the lazy materialization buffer are either not hitting the caches at any level or only a subset of the levels does. A goal is to delay as much as possible a storage access operation, to make sure that the amount of data fetched is significant. The reason behind this is that a storage access operation has an important cost. Fetching a big number of properties from the data layer through a single storage access operation is less costly than requesting the same amount of data through multiple storage accesses. Thus, with the lazy materialization buffer, it can be ensured that a storage access operation is performed only when the buffer is full, meaning that results are written out before more paths fetched from the runtime are materialized.

Unlike the materialized paths data structure, the data stored in the lazy materialization buffer contains more than just vertex identifiers (yids). Considering that a subset of the levels of these paths could potentially have hit the cache, the lazy materialization buffer also contains a result set which can store these properties. This result set is only used if caching is enabled, otherwise the lazy materialized buffer will simply act as a buffer used to process the paths in batches.

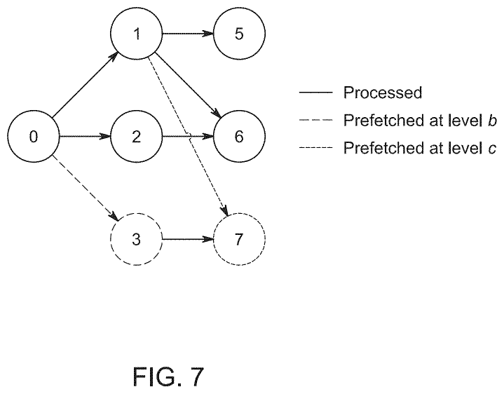

FIG. 6 illustrates a visual representation of the lazy materialization buffer when executing a graph query with the following path pattern (a)->(b)->(c) and projecting the age property at level (a) and the age property and the owner property at level (c).

In an embodiment, copying the available projected value from the cache(s) to the lazy materialization buffer makes it possible to decouple management of the cache with that of the lazy materialization buffer. In particular, the cache does not have to interact with the lazy materialization buffer to decide what value to evict.

Fetching Properties. In an embodiment to fetch properties from the underlying tables of the graph, the storage access operators identify rows according to yids. Sets of yids can be encoded in bitmaps which are passed to the storage access operators to retrieve columns from rows associated with the yids.

A mapping from a vid to properties is used to reconstruct paths after executing the storage accesses. Whenever a storage access is executed to recover the properties of some rows, the yids of the corresponding rows are projected.

The storage access results can then directly be added in the cache by reading the vid and the properties from the results. In the cache, the vid is used as key and the properties as values.

For instance, assume the graph query shown in Table 4 and the corresponding graph schema illustrated in FIG. 3.

TABLE 4

SELECT * FROM GRAPH TABLE(MY_GRAPH, MATCH (a) −> (b) −> (c)
COLUMNS (a.age, c.age)) T;

Whenever storage accesses are executed, the following logical SQL queries shown in Table 5 will be executed.

TABLE 5
// If requesting the age property at the root (a). Given that
// the root only has one vertex table (Person table)
SELECT /*+ IN_MEMORY */ age, vid FROM Person;
// If Requesting the age property at the leaves (c). Given that
// the leaves have two vertex tables (Warehouse and Shop
// table). The SQL query corresponding to the tables we want
// the data from will be executed. It can be one of the
// following, or even both if the paths projected access
// both tables.
SELECT /*+ IN MEMORY */ age, vid FROM Shop;
SELECT /*+ IN MEMORY */ age, vid FROM Warehouse;

When caching is not enabled, paths computed by the graph query runtime are extracted and stored in a path results buffer. Once the path results buffer is full, storage accesses are launched in order to fetch properties of the vertices in the path results buffer. In an embodiment, the size of the path results buffer, also known as the BATCH_SIZE, can be tuned based on the query and shape of the queried graph. In an embodiment, the path results buffer and the materialized paths data structure are the same data structure, which behaves differently depending on whether when caching is enabled or not. When caching is enabled, paths whose properties are fully present in the caches are stored in the materialized paths data structure, and paths whose properties are not fully present in the caches are stored in the lazy materialization buffer, as described above.

### Data Prefetching

Storage accesses have a high fixed cost that can be amortized by prefetching data when refreshing the caches, such as when the lazy materialization buffer is full. The amount of data to prefetch may be dictated by the following:
The size of cache is always >=BATCH_SIZE (the number of paths fetched from the runtime at a time).
Fetching missing properties from the lazy materialization buffer will refill the cache with N properties such that N<=BATCH_SIZE.
The remaining space is available for prefetching data.

In an embodiment, the current solution includes at least two data prefetching algorithms. The algorithm used is based on the level of the path in which data is prefetched. Assume, without loss of generality, that a graph query with the path pattern (a)->(b)->(c) is being executed.

Source level (a): The runtime guarantees that the order in which matching paths are returned, is ordered with respect to the source of the paths. This invariant simplifies the prefetching algorithm. Given a set of matching paths and a maximum value x, where x is the source vertex with the largest identifier of the set, for every vertex y that is prefetched, it should be ensured that y>x. This means that the vertices which are going to be prefetched have not yet been considered as potential source of paths by the graph query runtime. Thus, by prefetching them, their properties are obtained in advance and potential later storage access operations are avoided. Table 6 shows a pseudo code of the algorithm.

```
TABLE 6
/* Prefetching at the root uses the maximum vertex identifiers
of all the roots present in the lazy materialization buffer. */
root_prefetching (cache_size, max_vid, buffer_size) {
  /* Verify if we can prefetch more values */
  if (cache_size > buffer_size) {
    /* Compute the number of vertices that can be prefetched */
    remaining = cache_size-buffer_size;
    /* Compute how many vids can have their columns prefetch,
    based on the projected column data types and the space
    left. */
    numVids = numVidsToPrefetch(remaining, column_list);
    /* Pre-fetch */
    prefetch_for_vids (numVids, column_list);
  }
}
```

Other levels (b), (c): Prefetching data at other levels leverages the information given by the graph query runtime and an in-memory graph index (e.g., CSR). When prefetching at level i, a parent match operator is accessed at level i−1. The parent match operator will have a certain number of vertices that are the sources of the subpaths starting at level i−1. Using Si and Li arrays, which contains respectively the indices of the first and last unprocessed neighbors of the vertices at level i−1, the neighbors (e.g., vertices at level i that are not processed yet) can be prefetched.

This technique ensures that the data being prefetched will appear in the upcoming paths returned by the graph query runtime. This will increase the number of cache hits of the current solution and, therefore, significantly reduced the total number of storage accesses executed.

In the situation where a source vertex at level i−1 has no unprocessed neighbors, the space is still used to prefetch data randomly. The algorithm will simply get the vid of the source vertex at level 1 and prefetch the next n vertices based on the vid, where n is the number of vertices that each source vertex can prefetch. Table 7 shows a pseudo code of the algorithm.

```
TABLE 7
prefetch (ir_node, buffer_size) {
  /* Get the parent Si array of the parent match operator */
  siArray = ir_node−>parent−>si_array;
  /* Get the parent Li array of the parent match operator */
  liArray = ir_node−>parent−>li_array;
  /* Get the CSR srcArray to recover vertex identifiers */
  srcArray = ir_node−>csr_srcArray;
  /* Get the number of sources */ nb_src = siArray −>size;
  /* Get the cache size */
  cache_size = ir_node−>cache−>cache_size;
  /* Computes the number of neighbors each source can prefetch */
  ni_per_src = (buffer_size - cache_size) /nb_src;
    /* Iterate over the si array and prefetch ni_per_src
    neighbors */
    for (i = 0; i < siArray−>size; ++i) {
      /* Get the index of the first unprocessed neighbor */
      start_ni = siArray[i];
      /* Get the index of the last unprocessed neighbor or the
      maximum neighbor we can prefetch */
      end_ni = min (start_ni + ni_per_src, liArray[i]);
      /* Iterate over the neighbor indices in order to retrieve
      their vertex ids */
      while (start_ni < end_ni) {
        /* Convert neighbor index into vertex identifier */
        vid = srcArray[start_ni];
        /* Mark this vid to be prefetched */
        prefetch(vid) ;
      }
    }
}
```

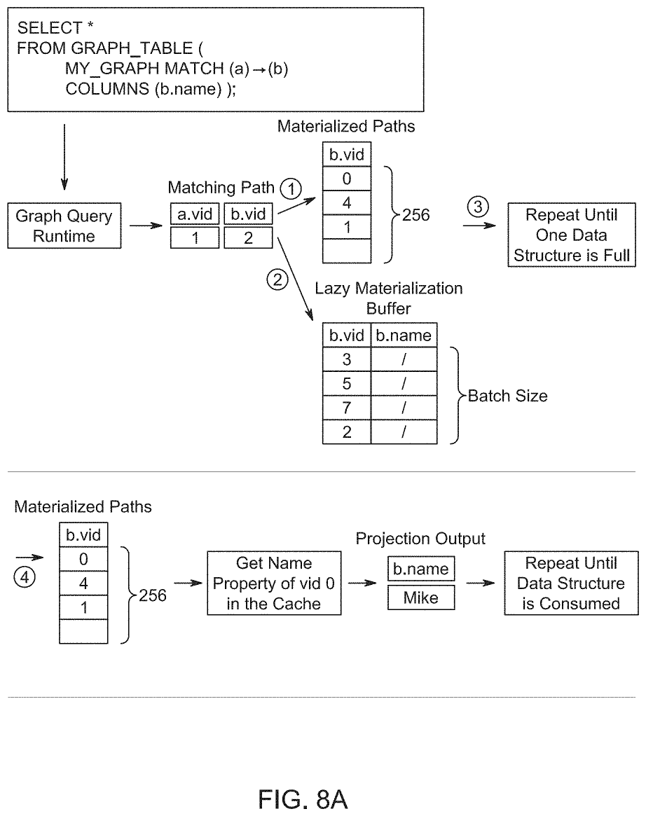

FIG. 7 illustrates a visual representation of the vertices being prefetched on a graph when executing a graph query with the path pattern (a)->(b)->(c). In FIG. 7, properties of graph components (e.g., vertices) with vid 3 and vid 7 are prefetched at level (b) and level (c).

In an embodiment, the graph pattern query engine may implement a filter using a bit-vector indexed by vid when prefetching data. A vertex is filtered out if the bit indexed by its vid is not set. IR nodes of an instantiation tree may be decorated with bit vectors. Pre-fetching takes filters into account by avoiding prefeteching values of filtered out vertices. This also allows for optimize use of the cache space and reduce the amount of data needlessly prefetched.

### Specialized Control Flows

The control flows of the GRAPH_TABLE operator is implemented such that they minimize the number of storage accesses executed. In an embodiment, the current solution has different control flows based on the configuration used in the system and the query being executed. There are three different control flows. The first control flow is for COUNT ( ) queries. Given that these queries have no property projections, a simpler and more efficient control flow is used. The second control flow is when the memory available in the system is large enough to materialize all the column values involved in projections from all the relational tables in the graph in memory (as uncompressed arrays). Finally, the last control flow is used with a system with strong memory constraints and the graph query project properties. The memory constraints of the system prevent all the tables to materialize in memory and, thus, it is necessary to efficiently use the memory available to have good performance.)

COUNT(*) queries. The control flow for COUNT ( ) queries is the simplest of the control flows. Consider a graph query which only requires counting the number of paths matching the path pattern (e.g., no properties are projected). A counter may be used to increment whenever a matching path is extracted from the runtime. When no more paths are available, the result stored in the counter is output.

Full materialization. When the memory available is sufficient to materialize all the properties involved in projections from all the storage elements, the second special control flow works as follows:
1. At query start time, for every level in the graph query, storage accesses are executed on storage elements from which properties are to be projected. For every storage access, any filters that the graph query imposes are considered. For example, if the graph query is MATCH (a) WHERE a.age>20 COLUMNS (a, name), and a binds to VT1 and VT2, only the names for rows with age greater than 20 are fetched only from VT1 and VT2.
2. When the storage accesses results are ready, they are stored in the caches.
3. At query runtime, the control flow simply extracts matching paths from the graph query runtime and directly fetches the properties from the caches. Given that the storage accesses requested all the properties, it is ensured that they are present in the caches. Notice that lazy materialization buffer is not used anymore.
4. Once the properties are fetched, the output is simply output.

Limited memory. When executing the graph query in a system with limited amount of memory, the third specialized control flow is used. This third control flow uses all the mechanisms and data structures discussed before. It works as follows:
1. Matching paths (e.g., each being an ordered sequence of vertex ids matching the input path pattern) computed by the graph query runtime are extracted, until either the materialized paths data structure or the lazy materialization buffer is full. For every path given by the graph query runtime, the following steps are performed:
2. Check if all the properties of the vertices in the path are already cached. If so, this path is saved in the materialized paths data structure.
3. Otherwise, this path is saved in the lazy materialization buffer. The properties of the vertices in the path, that are in the caches (if any), are copied and saved in the result set of the lazy materialization buffer. The goal of this step is to delay the full materialization of these paths as much as possible.
4. Once any of these two data structures are full, paths are no longer extracted from the graph query runtime and result rows are produced to a consuming operator in the query plan. If there are paths in the materialized paths data structure, they are consumed directly by fetching the properties from the caches and outputting them. This operation will be done until this data structure is empty.
5. Then, once the lazy materialization buffer is full, storage accesses are launched in order to fetch properties of the vertices present in the buffer. At the same time, the data prefetching algorithm is used to prefetch properties for the upcoming paths.
6. When the storage accesses results are ready, they are stored in caches. Then, paths are consumed from the lazy materialization buffer by fetching the properties from the caches and outputting them. This operation will be done until the buffer is empty.
7. The operation of extracting paths from the graph query runtime can restart.

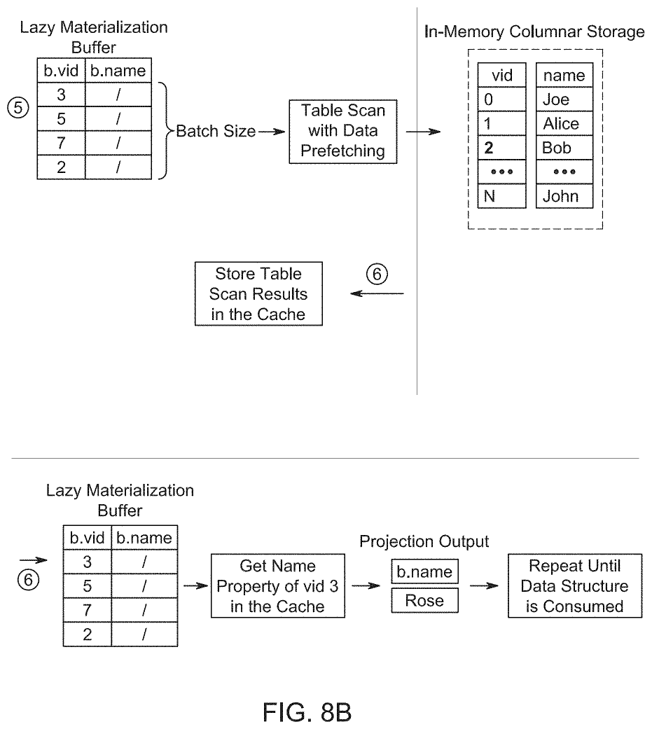

FIGS. 8A-8B illustrate a visual representation of the control flow presented above. In FIGS. 8A-8B, the input path pattern is (a)->(b). A matching path is extracted from or otherwise provided by the graph query runtime. Each matching path provided by the graph query runtime is an ordered sequence of vertex ids matching the input path pattern of (a)->(b). It is determined whether all the properties of the vertices in the matching path are already cached. If so, this path is saved in the materialized paths data structure at (1); otherwise, this path is saved in the lazy materialization buffer at (2). At (3), matching paths are continuously extracted and stored in either the materialized paths data structure or the lazy materialization buffer, until one of them is full. If there are paths in the materialized paths data structure, then the paths are consumed directly by fetching the properties from the caches and outputting them at (4). If the lazy materialization buffer is full, storage accesses are launched in order to fetch properties of the vertices present in the buffer at (5). At the same time, the data prefetching algorithm is used to prefetch properties for the upcoming paths. When the storage accesses results are available, they are stored in caches at (6). Then, paths are consumed from the lazy materialization buffer by fetching the properties from the caches and outputting them.

An entry function of the GRAPH_TABLE operator (e.g., the function that the parent operator calls in order to get more rows from the GRAPH_TABLE operator) executes the control flow previously described ensuring that the materialized paths data structure and the lazy materialization buffer are consumed correctly and in the right order. Table 8 shows a pseudo code of the algorithm.

```
TABLE 8
fetch() {
  /* If the materialized paths data structure is not empty, we
  can extract a path from it and get the properties from the
  cache since if a path is in this data structure, it means
  that it hits the cache at every level. */
  if (materialized_paths is not empty) {
    /* Write the next path into the output */
    output_next_path(materialized_paths);
  /* The lazy_materialization_buffer is projected only when it
  is full */
  } else if (lazy_materialization_buffer is full AND
      lazy_materialization_buffer is not consumed
      entirely) {
    /* If the buffer has not yet been projected, it will not
    have the properties for all the paths. Thus, here we
    perform storage accesses once to recover the missing
    properties and save them */
    if (lazy materialization buffer does not have all the
      properties) {
      execute_storage_accesses (lazy_materialization_buffer
      ) ;
    }
    /* Write the next path into the output row(−set) */
    output_next_path (lazy_materialization_buffer) ;
  } else {
    /* Get the next paths from the runtime. This will fill
    the materialized_paths and the
    lazy_materialization_buffer. */
    get_next_matching_paths() ;
    /* Recurse only once */
    fetch();
  }
}
```

Table 9 shows a pseudo code of the function which extracts matching paths from the graph query runtime and puts them either in the materialized paths data structure or the lazy materialization buffer.

```
TABLE 9
get_next_matching_paths() {
  /* We can consume paths from the runtime as long as we can
  stored them */
  while (lazy_materialization_buffer not full OR
      materialized_paths not full) {
    /* Call the fetch method from the graph query runtime */
    path = runtime fetch();
    /* Check if all the levels of the path hit the cache */
    if (path_hit_cache(path)) {
      /* Save the vertex identifiers of the path in the
      materialized paths */
      materialized paths.add(path);
    } else {
      /* Save the vertex identifiers of the path in the lazy
      materialization buffer */
      lazy_materialization_buffer.add(path);
      /* Save the properties of the levels hitting the cache in
      the lazy materialization buffer result set */
      lazy_materialization_buffer.addProperties(path);
    }
  }
}
```

### Memory Allocation Algorithm

Based on the memory available in the system, the current solution determines the best configuration possible to execute graph queries with property projections. By looking at graph connectivity and heterogeneity of the graph, a memory allocation algorithm of the current solution decides, at query compilation time:
If caching and data prefetching should be enabled based on graph connectivity; and
How the memory should be split between the levels based on graph heterogeneity.

Algorithm Inputs. To compute graph connectivity, statistics about the degree of each vertex of the graph are gathered. The statistics extracted from the graph are the average, median and variance degree. Using these statistics, it can be assessed if the graph is highly connected or not according to the following logic:
If the variance is low:
   If the average degree is high, it can be concluded that all the vertices have an important number of neighbors. Thus, it can be characterized the graph is highly connected.
   If the average degree is low, it means that the vertices of the graph do not have many neighbors. In this case, the graph is not considered as being highly connected.
If the variance is high:
   If the median degree is high, then the graph is considered as highly connected. This means that most of the vertices of the graph have a high number of neighbors but also that the graphs contain outliers. Outliers are vertices that have a much more important number of neighbors than the median.
   If the median degree is low, then the graph is still considered as highly connected. The reason is that, although the median is low, meaning that most of the vertices of the graph do not have a large number of neighbors, the graph contains outliers. The outlier vertices of the graph are expected to generate most of the paths matching a given path pattern. Thus, in this case, prefetching neighbors and caching these vertices will be beneficial, which why the graph is considered as being highly connected.

A graph is heterogeneous when the vertices and edges are partitioned in different types. In that case, all the edges from the same partition match vertices from one partition to vertices to some other partition, possibly equal to the first one. These graphs are composed of multiple vertex and edge tables.

Enable caching/data prefetching based on connectivity. Data prefetching and caching is only enabled on graphs that are considered highly connected. The reason is that highly connected graphs contain vertices with an important number of neighbors. These highly connected vertices allow the data prefetching algorithms to prefetch their neighbors efficiently.

The more neighbors a vertex has, the more likely it will still have unprocessed neighbors when the lazy materialization buffer is full and storage accesses are executed. Thus, the prefetching algorithm will be able to prefetch these unprocessed neighbors and ensure a cache hit at the next iterations, leading to less storage accesses executed.

On the other hand, having low connectivity means that there are no highly connected vertices. Thus, most vertices will not have unprocessed neighbors, so the data prefetching algorithm will prefetch vertices randomly. This cannot ensure an efficient execution of the graph query, so data prefetching and caching are disabled. The memory used for caching and prefetching can be repurposed for a bigger batch size.

Allocate memory across different levels. Once it is determined whether or not caching and data prefetching should be enabled, the memory available is efficiently distributed between the levels of the path pattern. Splitting the memory is based on the graph heterogeneity and defines how much memory is given to the caches at every level.

It is observed that more memory should be given to the leaf level than the source level. The reason is that the deeper into the path, the more random the matching vertices become. Thus, having a small cache size when close to the source is enough to have good performance, given that the paths extracted from the graph query runtime will contain many duplication at these levels. On the contrary, the randomness when closer to the leaf level, requires a larger cache size to ensure more cache hits.

On heterogeneous graphs, given that the connectivity at each level can vary significantly, each level is looked at independently. For example, when processing the path (a)->(b)->(c)->(d), the hops from (b)-(c) can have much higher connectivity than the one from (c)-(d). In this case, a larger cache size is used for level (b) than for (c) as data prefetching and caching are more likely to give significant improvements for (b) than for (c). On the other hand, levels with low connectivity (say (c)) will not benefit from data prefetching and caching as much. Thus, a smaller cache size should be used.

Overview of the control flow for the memory allocation algorithm. Pattern specialization is a binding of graph query variable to relational tables. For example, if (a)->(b)->(c)->(d) is the graph query, then (a:vt1)->(b:vt2)->(c:vt3)->(d:vt4) is a pattern specialization. An example pattern specialization is discussed in co-pending U.S. application Ser. No. 17/080,698, titled “Efficient Compilation of Graph Queries on top of SQL Based Relational Engine,” filed Oct. 26, 2020,” wherein the entire contents of which are hereby incorporated by reference as if fully set forth herein.

In an embodiment, a tuning algorithm of the current solution for every pattern specialization in a graph query works as follows:

The first step is to check if the estimation of the size of the result set is low enough to simply process the paths matching the path pattern using only batch processing. This means that the system will simply extract all the matching paths from the runtime in a single batch. Then, it will execute the storage access to recover the properties. If the memory available is enough to process the paths in a single batch, then the system should execute the graph query this way, given that it will minimize the number of storage accesses executed.

If the memory available is not enough to process the paths in a single batch, then the system will try to request the memory needed to materialize all the relational tables in memory. If this is possible, then the second control flow defined previously will be used.

Otherwise, it will determine the amount of memory available for processing the graph query (M) and it will try to best partition it between cache structures at different levels and the batch size.

It will determine if caching and data prefetching should be enabled at every level. As explained before, the algorithm will only enable caching and data prefetching if the graph has high connectivity.

Once the algorithm determined if caching or prefetching should be enabled at every level, a total memory budget is fixed for caching (MC). The remaining memory (M−MC) will be used for the batch size.

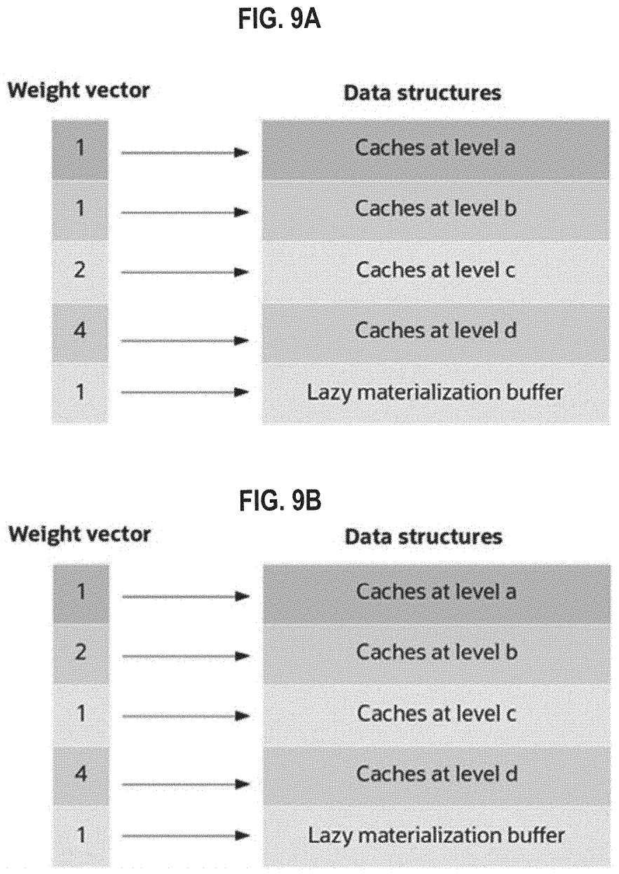

The algorithm then tries to best split MC between the levels that use caching, as follows:
The algorithm divides the memory into non-equal parts and provide more memory for the caches at the last levels of the path pattern. For instance, given the path pattern (a)->(b)->(c)->(d), FIG. 9A illustrates how the weight vector dividing the memory will look like and the corresponding data structures the weight is referring to.
On heterogeneous graphs, the weight vector will be determined based on the connectivity of the in-memory graph index (e.g., CSR) at each level. For instance, given the path pattern (a)->(b)->(c)->(d) and assuming that the connectivity of each CSR is ordered as follows, CSR (d)>CSR (b)>CSR (c)>CSR (a), then FIG. 9B illustrates how the weight vector dividing the memory will look like and the corresponding data structures the weight is referring to.

### Process Flow Example

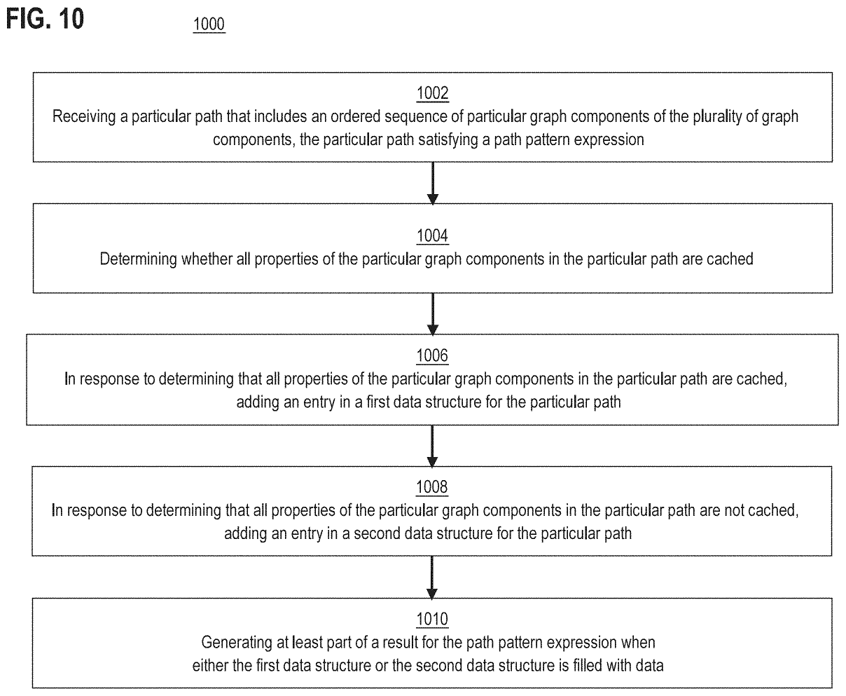

FIG. 10 illustrates an example flow diagram that depicts a process 1000 for projecting properties of generated paths when a path pattern expression of a query is evaluated against an in-memory representation of a graph. The graph includes a plurality graph components, such as vertices and edges. The query projects one or more graph properties of the plurality of the graph components.

At step 1002, a particular path that includes an ordered sequence of particular graph components of the graph is received. In an embodiment, the particular path, computed by the graph query runtime, satisfies the path pattern expression.

At step 1004, it is determined whether all properties of the particular graph components in the particular path are cached. In an embodiment, each storage element (e.g., table) associated at each level of the path pattern expression is associated with an independent cache. A size of a particular cache is dependent on which level of the path pattern expression a corresponding storage element is associated with. In an embodiment, an amount of memory available for processing the query is partitioned at least between caches at different levels of the path pattern expression.

In an embodiment, a cache for a storage element includes a mapping from a graph identifier of a graph component (e.g., vids) to properties projected at a corresponding level. In the cache, vids are used as key and properties as values. The cache is filled after getting results from a storage access (e.g., table access).

In an embodiment, caches relevant to the particular path (e.g., caches of those tables that contain the particular graph components whose properties are being projected) are checked to determine whether all properties of the particular graph components in the particular path are cached.

At step 1006, in response to determining that all properties of the particular graph components in the particular path are cached, an entry for the particular path is added in a first data structure. If the properties of all the levels doing projections are already cached, it means that this particular path can be written out, without needing to perform any storage access. In an embodiment, the first data structure is a materialized paths data structure. Each entry in the first data structure includes a graph identifier of each graph component, of a specific path, for which a property of a respective graph component is being projected.

At step 1008, in response to determining that all properties of the particular graph components in the particular path are not cached, an entry for the particular path is added in a second data structure. In an embodiment, the second data structure is a lazy materialization buffer. Each entry in the second data structure includes a graph identifier of each graph component, of a specific path, for which a property of a respective graph component is being projected and a property value of the property of the respective graph component if the property value is available from one or more caches.

At step 1010, at least part of a result for the path pattern expression is generated when either the first data structure or the second data structure is filled with data. Once any of these two data structures are full, paths are no longer extracted from the graph query runtime in order to start generating result rows.

In an embodiment, when the first data structure is full, properties from one or more caches are fetched for each entry in the first data structure. In an embodiment, yids in the first data structure are used as keys to retrieve properties from the one or more caches.

In an embodiment, when the second data structure is full, a storage access is performed to obtain and to cache property values of properties of those graph components identified in the second data structure that are unavailable in the second data structure. Afterwards, properties from one or more caches are fetched for each entry in the second data structure. In an embodiment, yids in the second data structure are used as keys to retrieve properties from the one or more caches.

At the same time, properties for upcoming paths may be prefetched in some embodiments. For example, potential graph components in upcoming paths each satisfying the path expression, may be identified from the in-memory representation of the graph. The storage access is performed also to obtain and to cache property values of properties of the potential graph components in the upcoming paths.

Compared to a join-oriented approach (e.g., processing the query using a JOIN engine that does sequential accesses), the current solution leverages the benefits of having a specialized graph index (e.g., CSR) encoding a graph topology both for traversing paths and projecting properties. In contrast to the join oriented approach, which constructs hash tables for every graph query executed to join the relation tables involved, the specialized graph index is constructed once, cached, and reused for every graph query executed by multiple sessions. The current solution does not only save time by reusing existing graph indices and not constructing hash-maps at runtime, but also takes the full advantage of having a specialized graph index which allows traversal of the graph in an optimal manner, leading to identifying the paths that match the original graph query in a faster way than a JOIN engine would do.

Compared to an approach that materializes the whole properties needed for projections in memory, the current solution achieves a much smaller memory footprint than materializing the whole properties in memory while maintaining the same level of performance.

### DBMS Overview

Embodiments of the present invention are used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

A database comprises data and metadata that is stored on a persistent memory mechanism, such as a set of hard disks. Such data and metadata may be stored in a database logically, for example, according to relational and/or object-relational database constructs.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, (e.g. Oracle Database 11g). SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

An SQL statement includes one or more query blocks. A query block is the basic unit of a SQL statement that specifies a projection operation (e.g. columns specified in a SELECT clause) on a row source (i.e. table, inline view, view referenced by a FROM clause), and may specify additional operations on the row source such as joining and grouping. A query block may be nested within another “outer” query block. A nested query block may be a subquery or inline view. A query block may be an argument to the UNION clause along with another query block, as illustrated by SQL statements described earlier.

A graph pattern query is a query that specifies a pattern of connected vertices and edges to match within a graph. A graph pattern query may be a statement that conforms to a graph query language. Examples of a graph query language include PGQL, GQL, and Gremlin. PGQL is described in PGQL 1.3 Specification, 24 Mar. 2020, the contents of which are incorporated herein by reference. Gremlin is described in Apache TinkerPop, 3.4.8, TinkerPop Documentation. GQL is being developed by ISO/IEC JTC 1/SC 32 WG3.

A database is defined by a database dictionary. A database dictionary comprises metadata that defines database objects contained in a database. In effect, a database dictionary defines much of a database. Database objects include tables, table columns, and tablespaces. A tablespace is a set of one or more files that are used to store the data for various types of database objects, such as a table. If data for a database object is stored in a tablespace, a database dictionary maps a database object to one or more tablespaces that hold the data for the database object.

A database dictionary is referred to by a DBMS to determine how to execute database commands submitted to a DBMS. Database commands can access or execute the database objects that are defined by the dictionary. Such database objects may be referred to herein as first class citizens of the database.

A database dictionary may comprise multiple data structures that store database metadata. A database dictionary may for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the column names and datatypes of the columns, and one or more files or portions thereof that store data for the table. Metadata in the database dictionary defining a procedure may specify a name of the procedure, the procedure's arguments and the return data type and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user defined function implemented in a JAVA class may be defined in part by the database dictionary by specifying the name of the users defined function and by specifying a reference to a file containing the source code of the Java class (i.e., .java file) and the compiled version of the class (i.e., .class file).

Generally, data is stored in a database in one or more data containers, each container contains records, and the data within each record is organized into one or more fields. In relational database systems, the data containers are typically referred to as tables, the records are referred to as rows, and the fields are referred to as columns. In object-oriented databases, the data containers are typically referred to as object classes, the records are referred to as objects, and the fields are referred to as attributes. Other database architectures may use other terminology. Systems that implement the present invention are not limited to any particular type of data container or database architecture. However, for the purpose of explanation, the examples and the terminology used herein shall be that typically associated with relational or object-relational databases. Thus, the terms “table”, “row” and “column” shall be used herein to refer respectively to the data container, record, and field.

### Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

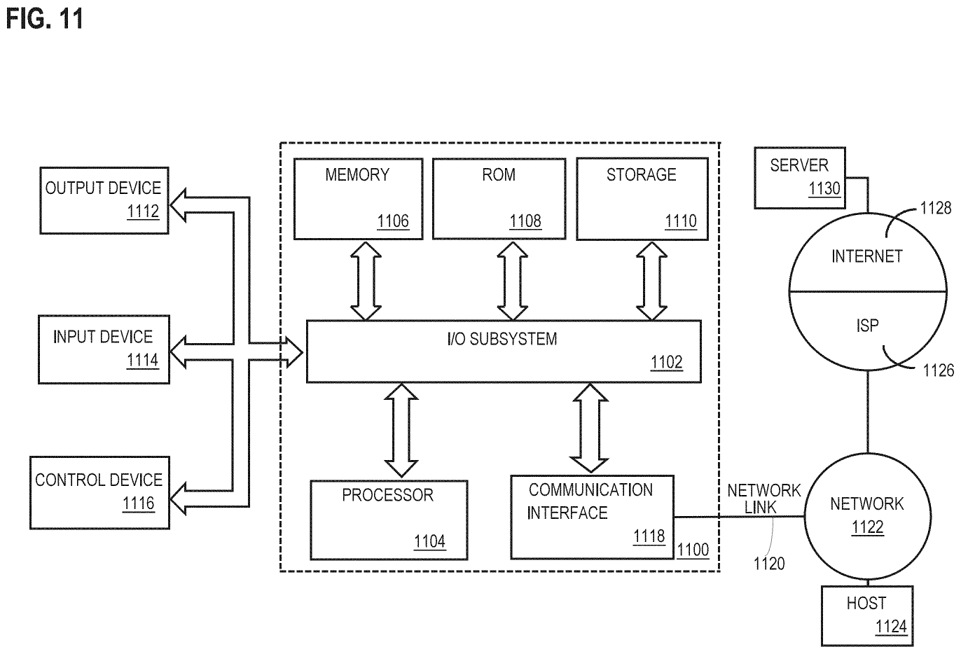

FIG. 11 is a block diagram that illustrates an example computer system with which an embodiment may be implemented. In the example of FIG. 11, a computer system 1100 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 1100 includes an input/output (I/O) subsystem 1102 which may include a bus and/or other communication mechanism(s) for communicating information and/or instructions between the components of the computer system 1100 over electronic signal paths. The I/O subsystem 1102 may include an I/O controller, a memory controller and at least one I/O port. The electronic signal paths are represented schematically in the drawings, for example as lines, unidirectional arrows, or bidirectional arrows.

At least one hardware processor 1104 is coupled to I/O subsystem 1102 for processing information and instructions. Hardware processor 1104 may include, for example, a general-purpose microprocessor or microcontroller and/or a special-purpose microprocessor such as an embedded system or a graphics processing unit (GPU) or a digital signal processor or ARM processor. Processor 1104 may comprise an integrated arithmetic logic unit (ALU) or may be coupled to a separate ALU.

Computer system 1100 includes one or more units of memory 1106, such as a main memory, which is coupled to I/O subsystem 1102 for electronically digitally storing data and instructions to be executed by processor 1104. Memory 1106 may include volatile memory such as various forms of random-access memory (RAM) or other dynamic storage device. Memory 1106 also may be used for storing temporary variables or other intermediate information during execution of instructions to be executed by processor 1104. Such instructions, when stored in non-transitory computer-readable storage media accessible to processor 1104, can render computer system 1100 into a special-purpose machine that is customized to perform the operations specified in the instructions.

Computer system 1100 further includes non-volatile memory such as read only memory (ROM) 1108 or other static storage device coupled to I/O subsystem 1102 for storing information and instructions for processor 1104. The ROM 1108 may include various forms of programmable ROM (PROM) such as erasable PROM (EPROM) or electrically erasable PROM (EEPROM). A unit of persistent storage 1110 may include various forms of non-volatile RAM (NVRAM), such as FLASH memory, or solid-state storage, magnetic disk, or optical disk such as CD-ROM or DVD-ROM and may be coupled to I/O subsystem 1102 for storing information and instructions. Storage 1110 is an example of a non-transitory computer-readable medium that may be used to store instructions and data which when executed by the processor 1104 cause performing computer-implemented methods to execute the techniques herein.

The instructions in memory 1106, ROM 1108 or storage 1110 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 1100 may be coupled via I/O subsystem 1102 to at least one output device 1112. In one embodiment, output device 1112 is a digital computer display. Examples of a display that may be used in various embodiments include a touch screen display or a light-emitting diode (LED) display or a liquid crystal display (LCD) or an e-paper display. Computer system 1100 may include other type(s) of output devices 1112, alternatively or in addition to a display device. Examples of other output devices 1112 include printers, ticket printers, plotters, projectors, sound cards or video cards, speakers, buzzers or piezoelectric devices or other audible devices, lamps or LED or LCD indicators, haptic devices, actuators, or servos.

At least one input device 1114 is coupled to I/O subsystem 1102 for communicating signals, data, command selections or gestures to processor 1104. Examples of input devices 1114 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 1116, which may perform cursor control or other automated control functions such as navigation in a graphical interface on a display screen, alternatively or in addition to input functions. Control device 1116 may be a touchpad, a mouse, a trackball, or cursor direction keys for communicating direction information and command selections to processor 1104 and for controlling cursor movement on display 1112. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 1114 may include a combination of multiple different input devices, such as a video camera and a depth sensor.

In another embodiment, computer system 1100 may comprise an internet of things (IoT) device in which one or more of the output device 1112, input device 1114, and control device 1116 are omitted. Or, in such an embodiment, the input device 1114 may comprise one or more cameras, motion detectors, thermometers, microphones, seismic detectors, other sensors or detectors, measurement devices or encoders and the output device 1112 may comprise a special-purpose display such as a single-line LED or LCD display, one or more indicators, a display panel, a meter, a valve, a solenoid, an actuator or a servo.

When computer system 1100 is a mobile computing device, input device 1114 may comprise a global positioning system (GPS) receiver coupled to a GPS module that is capable of triangulating to a plurality of GPS satellites, determining and generating geo-location or position data such as latitude-longitude values for a geophysical location of the computer system 1100. Output device 1112 may include hardware, software, firmware, and interfaces for generating position reporting packets, notifications, pulse or heartbeat signals, or other recurring data transmissions that specify a position of the computer system 1100, alone or in combination with other application-specific data, directed toward host 1124 or server 1130.

Computer system 1100 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 1100 in response to processor 1104 executing at least one sequence of at least one instruction contained in main memory 1106. Such instructions may be read into main memory 1106 from another storage medium, such as storage 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 1110. Volatile media includes dynamic memory, such as memory 1106. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 1102. Transmission media can also take the form of acoustic or light waves, such as those generated during radio-wave and infra-red data communications.

Various forms of media may be involved in carrying at least one sequence of at least one instruction to processor 1104 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 1100 can receive the data on the communication link and convert the data to a format that can be read by computer system 1100. For instance, a receiver such as a radio frequency antenna or an infrared detector can receive the data carried in a wireless or optical signal and appropriate circuitry can provide the data to I/O subsystem 1102 such as place the data on a bus. I/O subsystem 1102 carries the data to memory 1106, from which processor 1104 retrieves and executes the instructions. The instructions received by memory 1106 may optionally be stored on storage 1110 either before or after execution by processor 1104.

Computer system 1100 also includes a communication interface 1118 coupled to bus 1102. Communication interface 1118 provides a two-way data communication coupling to network link(s) 1120 that are directly or indirectly connected to at least one communication networks, such as a network 1122 or a public or private cloud on the Internet. For example, communication interface 1118 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 1122 broadly represents a local area network (LAN), wide-area network (WAN), campus network, internetwork, or any combination thereof. Communication interface 1118 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 1118 sends and receives electrical, electromagnetic, or optical signals over signal paths that carry digital data streams representing various types of information.

Network link 1120 typically provides electrical, electromagnetic, or optical data communication directly or through at least one network to other data devices, using, for example, satellite, cellular, Wi-Fi, or BLUETOOTH technology. For example, network link 1120 may provide a connection through a network 1122 to a host computer 1124.

Furthermore, network link 1120 may provide a connection through network 1122 or to other computing devices via internetworking devices and/or computers that are operated by an Internet Service Provider (ISP) 1126. ISP 1126 provides data communication services through a world-wide packet data communication network represented as internet 1128. A server computer 1130 may be coupled to internet 1128. Server 1130 broadly represents any computer, data center, virtual machine, or virtual computing instance with or without a hypervisor, or computer executing a containerized program system such as DOCKER or KUBERNETES. Server 1130 may represent an electronic digital service that is implemented using more than one computer or instance and that is accessed and used by transmitting web services requests, uniform resource locator (URL) strings with parameters in HTTP payloads, API calls, app services calls, or other service calls. Computer system 1100 and server 1130 may form elements of a distributed computing system that includes other computers, a processing cluster, server farm or other organization of computers that cooperate to perform tasks or execute applications or services. Server 1130 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 1130 may comprise a web application server that hosts a presentation layer, application layer and data storage layer such as a relational database system using structured query language (SQL) or no SQL, an object store, a graph database, a flat file system or other data storage.

Computer system 1100 can send messages and receive data and instructions, including program code, through the network(s), network link 1120 and communication interface 1118. In the Internet example, a server 1130 might transmit a requested code for an application program through Internet 1128, ISP 1126, local network 1122 and communication interface 1118. The received code may be executed by processor 1104 as it is received, and/or stored in storage 1110, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 1104. While each processor 1104 or core of the processor executes a single task at a time, computer system 1100 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### Software Overview

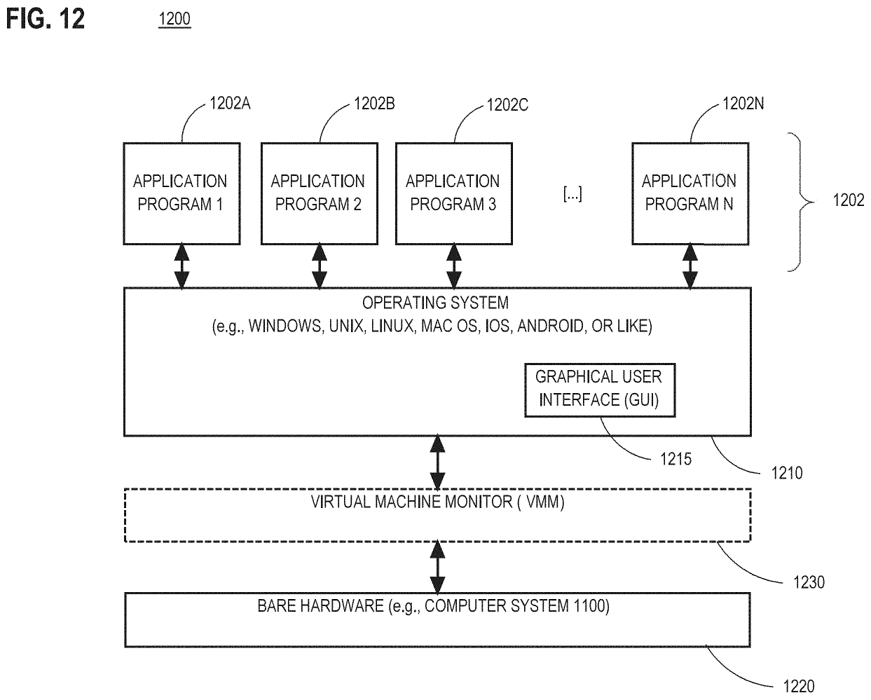

FIG. 12 is a block diagram of a basic software system 1200 that may be employed for controlling the operation of computing device 1100. Software system 1200 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1200 is provided for directing the operation of computing device 1100. Software system 1200, which may be stored in system memory (RAM) 1106 and on fixed storage (e.g., hard disk or flash memory) 1110, includes a kernel or operating system (OS) 1210.

The OS 1210 manages low-level aspects of computer operation, including managing execution of processes, memory allocation, file input and output (I/O), and device I/O. One or more application programs, represented as 1202A, 1202B, 1202C . . . 1202N, may be “loaded” (e.g., transferred from fixed storage 1110 into memory 1106) for execution by the system 1200. The applications or other software intended for use on device 1200 may also be stored as a set of downloadable computer-executable instructions, for example, for downloading and installation from an Internet location (e.g., a Web server, an app store, or other online service).

Software system 1200 includes a graphical user interface (GUI) 1215, for receiving user commands and data in a graphical (e.g., “point-and-click” or “touch gesture”) fashion. These inputs, in turn, may be acted upon by the system 1200 in accordance with instructions from operating system 1210 and/or application(s) 1202. The GUI 1215 also serves to display the results of operation from the OS 1210 and application(s) 1202, whereupon the user may supply additional inputs or terminate the session (e.g., log off).

OS 1210 can execute directly on the bare hardware 1220 (e.g., processor(s) 1104) of device 1100. Alternatively, a hypervisor or virtual machine monitor (VMM) 1230 may be interposed between the bare hardware 1220 and the OS 1210. In this configuration, VMM 1230 acts as a software “cushion” or virtualization layer between the OS 1210 and the bare hardware 1220 of the device 1100.

VMM 1230 instantiates and runs one or more virtual machine instances (“guest machines”). Each guest machine comprises a “guest” operating system, such as OS 1210, and one or more applications, such as application(s) 1202, designed to execute on the guest operating system. The VMM 1230 presents the guest operating systems with a virtual operating platform and manages the execution of the guest operating systems.

In some instances, the VMM 1230 may allow a guest operating system to run as if it is running on the bare hardware 1220 of device 1100 directly. In these instances, the same version of the guest operating system configured to execute on the bare hardware 1220 directly may also execute on VMM 1230 without modification or reconfiguration. In other words, VMM 1230 may provide full hardware and CPU virtualization to a guest operating system in some instances.

In other instances, a guest operating system may be specially designed or configured to execute on VMM 1230 for efficiency. In these instances, the guest operating system is “aware” that it executes on a virtual machine monitor. In other words, VMM 1230 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Extensions and Alternatives

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms, and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A method comprising:
evaluating a path pattern expression of a query against an in-memory representation of a graph;
wherein the graph includes a plurality of graph components;
wherein the query projects one or more graph properties of the plurality of graph components;
wherein evaluating the path pattern expression comprises:
receiving a particular path that includes an ordered sequence of particular graph components of the plurality of graph components, the particular path satisfying the path pattern expression;
determining whether all properties of the particular graph components in the particular path are cached;
in response to determining that all properties of the particular graph components in the particular path are cached, adding an entry in a first data structure for the particular path;
in response to determining that all properties of the particular graph components in the particular path are not cached, adding an entry in a second data structure for the particular path;
generating at least part of a result for the path pattern expression when either the first data structure or the second data structure is filled with data.

2. The method of claim 1, wherein each entry in the first data structure includes a graph identifier of each graph component, of a specific path, for which a property of a respective graph component is being projected.

3. The method of claim 1, wherein each entry in the second data structure includes a graph identifier of each graph component, of a specific path, for which a property of a respective graph component is being projected and a property value of the property of the respective graph component if the property value is available from one or more caches.

4. The method of claim 1, wherein generating the at least part of the result includes fetching properties from one or more caches for each entry in the first data structure.

5. The method of claim 1, wherein generating the at least part of the result includes:
performing a storage access to obtain and to cache property values of properties of those graph components identified in the second data structure that are unavailable in the second data structure;
fetching properties from one or more caches for each entry in the second data structure.

6. The method of claim 5, wherein performing the storage access includes:
identifying potential graph components in upcoming paths each satisfying the path pattern expression;
performing the storage access to obtain and cache property values of properties of the potential graph components in the upcoming paths.

7. The method of claim 6, wherein the potential graph components are identified from the in-memory representation of the graph.

8. The method of claim 6, wherein identifying the potential graph components in the upcoming paths comprises excluding components based on a bit-vector indexed by graph component identifier that identifies filtered graph components.

9. The method of claim 1, wherein each storage element associated at each level of the path pattern expression is associated with an independent cache.

10. The method of claim 1, wherein a size of a particular cache is dependent on which level of the path pattern expression a corresponding storage element is associated with.

11. The method of claim 1, wherein an amount of memory available for processing the query is partitioned at least between caches at different levels of the path pattern expression.

12. One or more non-transitory storage media storing sequences of instructions which, when executed by one or more processors, cause:
evaluating a path pattern expression of a query against an in-memory representation of a graph;
wherein the graph includes a plurality of graph components;
wherein the query projects one or more graph properties of the plurality of graph components;
wherein evaluating the path pattern expression comprises:
receiving a particular path that includes an ordered sequence of particular graph components of the plurality of graph components, the particular path satisfying the path pattern expression;
determining whether all properties of the particular graph components in the particular path are cached;
in response to determining that all properties of the particular graph components in the particular path are cached, adding an entry in a first data structure for the particular path;
in response to determining that all properties of the particular graph components in the particular path are not cached, adding an entry in a second data structure for the particular path;
generating at least part of a result for the path pattern expression when either the first data structure or the second data structure is filled with data.

13. The one or more non-transitory storage media of claim 12, wherein each entry in the first data structure includes a graph identifier of each graph component, of a specific path, for which a property of a respective graph component is being projected.

14. The one or more non-transitory storage media of claim 12, wherein each entry in the second data structure includes a graph identifier of each graph component, of a specific path, for which a property of a respective graph component is being projected and a property value of the property of the respective graph component if the property value is available from one or more caches.

15. The one or more non-transitory storage media of claim 12, wherein generating the at least part of the result includes fetching properties from one or more caches for each entry in the first data structure.

16. The one or more non-transitory storage media of claim 12, wherein generating the at least part of the result includes:
performing a storage access to obtain and to cache property values of properties of those graph components identified in the second data structure that are unavailable in the second data structure;
fetching properties from one or more caches for each entry in the second data structure.

17. The one or more non-transitory storage media of claim 16, wherein performing the storage access includes:
identifying potential graph components in upcoming paths each satisfying the path pattern expression;
performing the storage access to obtain and cache property values of properties of the potential graph components in the upcoming paths.

18. The one or more non-transitory storage media of claim 17, wherein the potential graph components are identified from the in-memory representation of the graph.

19. The one or more non-transitory storage media of claim 17, wherein identifying the potential graph components in the upcoming paths comprises excluding components based on a bit-vector indexed by graph component identifier that identifies filtered graph components.

20. The one or more non-transitory storage media of claim 12, wherein each storage element associated at each level of the path pattern expression is associated with an independent cache.

21. The one or more non-transitory storage media of claim 12, wherein a size of a particular cache is dependent on which level of the path pattern expression a corresponding storage element is associated with.

22. The one or more non-transitory storage media of claim 12, wherein an amount of memory available for processing the query is partitioned at least between caches at different levels of the path pattern expression.
